(19) United States
(12) Patent Application Publication
(10) Pub. No.: US 2009/0039230 A1
(43) Pub. Date: Feb. 12, 2009

(54) OUTDOOR TREE STAND

(75) Inventor: Lewis CHENG, Hong Kong (CN)

Correspondence Address: TROUTMAN SANDERS LLP, 600 PEACHTREE STREET , NE, ATLANTA, GA, 30308, US

(73) Assignee: Cindex Holdings Limited (a Hong Kong corporation), Hong Kong (CN)

(21) Appl. No.: 12/186,133

(22) Filed: Aug. 5, 2008

Related U.S. Application Data
(60) Provisional application No. 60/954,200, filed on Aug. 6, 2007.

(51) Int. Cl. F16M 13/00

(52) U.S. Cl. 248/523

(57) ABSTRACT

A tree stand is adapted to support a tree in a particular orientation. The tree stand includes a base adapted to receive the tree trunk, a plurality of leg assemblies extending outwardly from the base, and a plurality of feet positioned at the terminus of each leg assembly. The feet are adapted to be stabilized by stabilizing mechanisms to prevent the tree stand and tree from tipping or falling over. The tree stand includes feet that are adapted to provide improved stability, and enable both temporary and permanent use of the tree stand.

### CROSS REFERENCE TO RELATED APPLICATION

This application claims benefit, under 35 U.S.C. §119(e), of U.S. Provisional Application Ser. No. 60/954,200, filed 6 Aug. 2007, the entire contents and substance of which are hereby incorporated by reference.

### BACKGROUND

Embodiments of the present invention relate to tree stands and, more particularly, to a tree stand comprising feet adapted to provide improved stability, and enable both temporary and permanent use of the tree stand, primarily in an outdoor environment.

Stands for securing vertical posts, trees, and the like are well-known in the art. For example, stands for supporting trees, such as holiday or Christmas trees, are conventionally provided with detachable legs, making the stands easier to package and store at points of sale, transport home when purchased, and store after use.

Generally, a conventional tree stand for a Christmas tree is designed for indoor use, and includes a base, being a central, tubular member that is adapted to receive the trunk of the tree, and a number of legs extending from the base towards the ground. The legs can be snap-fit, hinged, or otherwise connected to the base to enable collapsibility. When the conventional tree stand is assembled, the legs typically extend from the base and terminate at the ground with a foot, which is adapted to support the tree to stand, preferably, off the ground.

An example of a tree stand is disclosed in U.S. Pat. No. 6,572,068 to Cheng, issued 3 Jun. 2003, which is hereby incorporated by reference.

Unfortunately, conventional indoor tree stands if used outdoors, have been found deficient because they can rather easily tip or fall, often due to instability with their feet. Various solutions to overcome this problem have been attempted, for example, by widening the distance of the feet from the base. Because the feet of the tree stand are simply a termination point, a gust of wind, a tumbling child, or other force can still cause the tree stand, and consequently the tree, to tip or fall over.

What is needed, therefore, is a stable outdoor tree stand that can be either temporarily or permanently secured, and thus the tipping or falling of a tree can be prevented. It is to such a device that the present invention is primarily directed.

### SUMMARY

Briefly described, embodiments of the present invention relate a stand for supporting a item. For instance, the stand is adapted to support a tree. In one embodiment, the stand is a tree stand for supporting the tree in a generally vertical orientation.

In an exemplary embodiment, the tree stand includes a base adapted to receive the tree trunk, a plurality of leg assemblies extending outwardly from the base, and a plurality of feet positioned at the terminus of each leg assembly. The feet are adapted to be stabilized by stabilizing mechanisms to prevent the tree stand and tree from tipping or falling over. The tree stand includes feet that are adapted to provide improved stability, and enable both temporary and permanent use of the tree stand.

These and other objects, features and advantages of the present invention will become more apparent upon reading the following specification in conjunction with the accompanying drawing figures.

### BRIEF DESCRIPTION OF THE DRAWINGS

FIG. 1 is a side, perspective view of a tree stand in an operational state, in accordance with an exemplary embodiment of the present invention.

FIG. 2 is another side, perspective view of the tree stand in the operational state, in accordance with an exemplary embodiment of the present invention.

FIG. 3 is a top, perspective view of the tree stand, in accordance with an exemplary embodiment of the present invention.

FIG. 4 is a side, perspective view of the tree stand, in a collapsed state, in accordance with an exemplary embodiment of the present invention.

FIG. 5 is a side view of the tree stand, in the operational state, in accordance with an exemplary embodiment of the present invention.

FIG. 6A is a perspective view of a foot for the tree stand, in accordance with an exemplary embodiment of the present invention.

FIG. 6B is a side view of the foot of FIG. 6A for the tree stand, in accordance with an exemplary embodiment of the present invention.

### DETAILED DESCRIPTION

To facilitate an understanding of the principles and features of various embodiments of the present invention, they are explained hereinafter with reference to their implementation in an illustrative embodiment. In particular, an illustrative embodiment of the invention is described in the context of being a tree stand. The tree stand is adapted to secure a tree enabling it to stand upright. The tree stand can be, for example, collapsible making it easy to store, and readily portable.

Embodiments of the invention are not, however, limited to a tree stand for supporting a tree. Embodiments of the present invention can be used to support many items. Embodiments of the invention are generally described herein in the context of being able to support a tree, in an approximately vertical orientation.

Additionally, the materials described hereinafter as making up the various elements of the present invention are intended to be illustrative and not restrictive. Many suitable materials that would perform the same or a similar function as the materials described herein are intended to be embraced within the scope of the invention. Such other materials not described herein can include, but are not limited to, materials that are developed after the time of the development of the invention, for example.

Embodiments of the invention include several embodiments of tree stands with improved feet enhancing stability of tree stands. The tree stand generally includes a base adapted to receive a trunk of a tree, a number of leg assemblies extending from the base towards the ground, and feet positioned at the termination point of each leg assembly, wherein each foot includes at least one aperture for receiving a securing device, such as a stake, screw, and/or nail. Use of such securing devices is most preferably suitable for outdoor use.

Referring now to the figures, wherein like reference numerals represent like parts throughout the view, embodiments of the present tree stand will be described in detail.

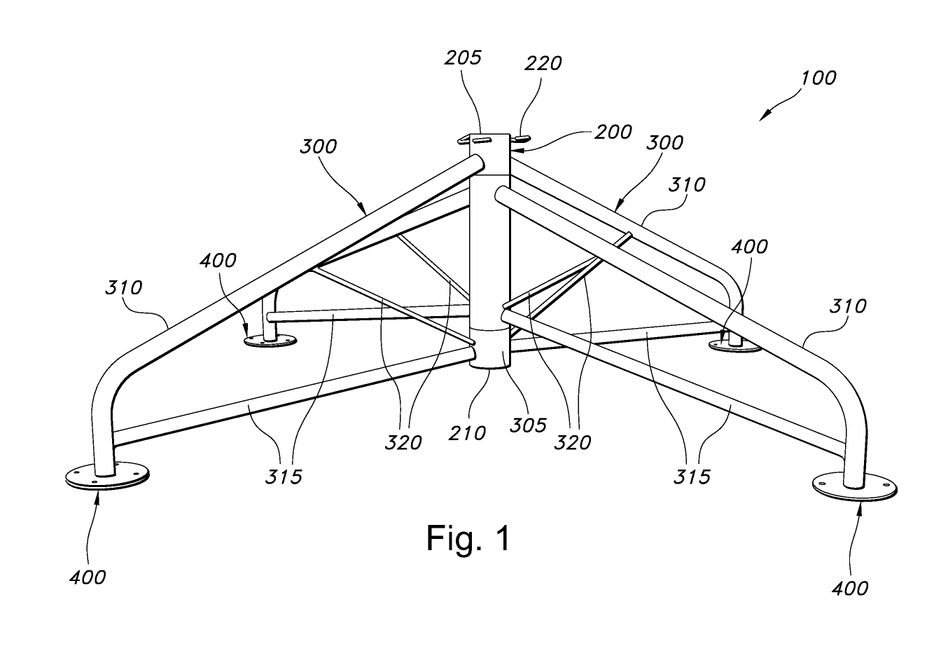

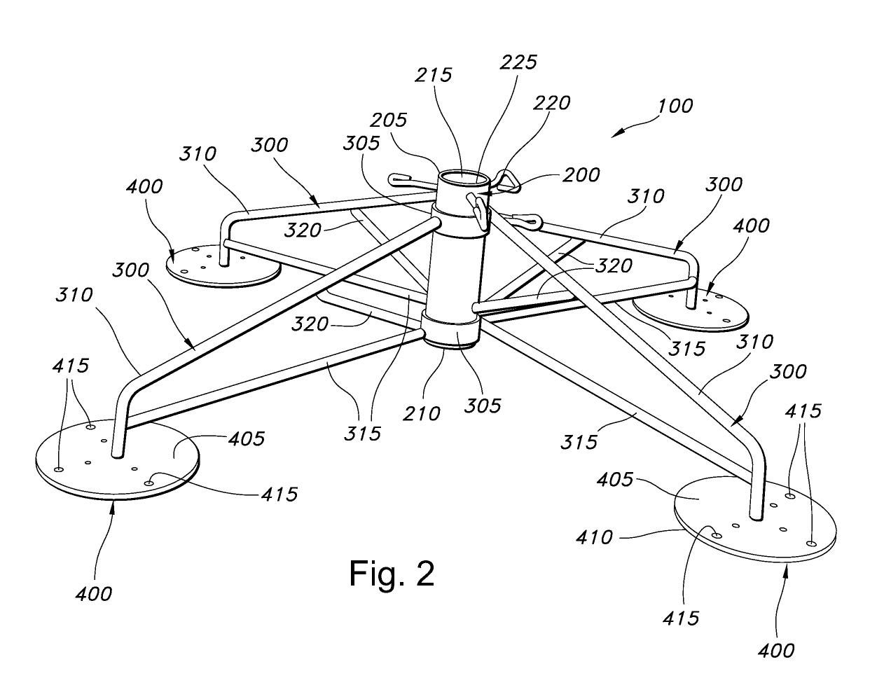

FIGS. 1-2 illustrate side, perspective views of a tree stand 100. The tree stand 100 includes a base 200, a plurality of leg assemblies 300, and a plurality of feet 400. The plurality of leg assemblies 300 of the tree stand 100 extend from the base 200 and terminate at the feet 400.

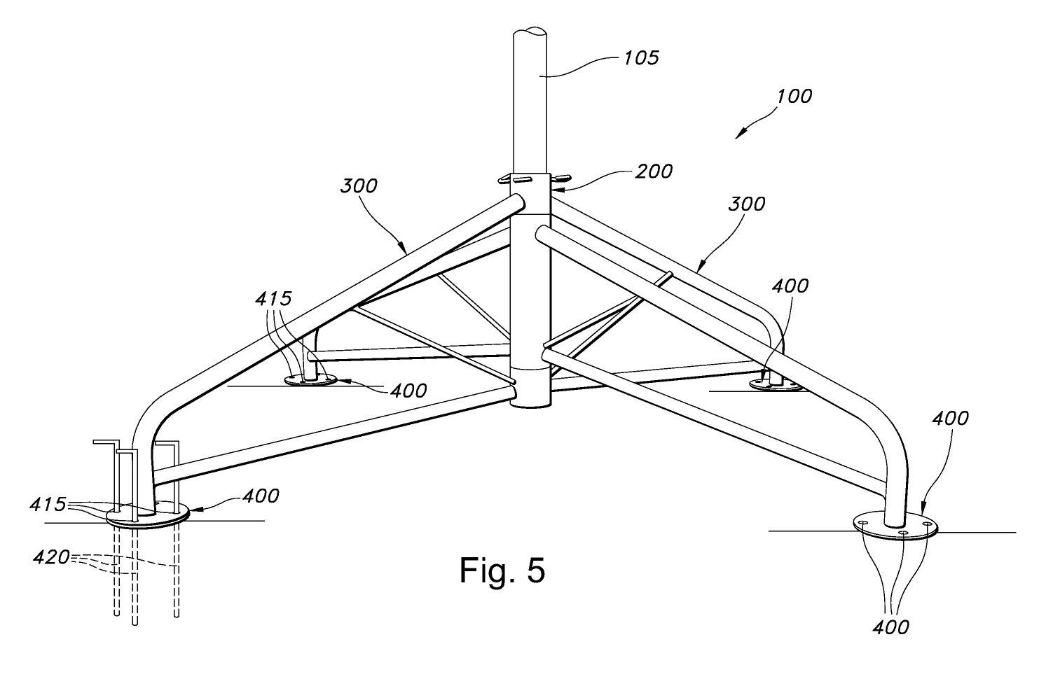

In an exemplary embodiment, the tree stand 100 is adapted to support an item, such as tree trunk 105 (see FIG. 5). For example, the tree stand 100 is designed to support the trunk of an artificial tree or a recently chopped-down living tree. As one skilled in the art would appreciate, the tree stand 100 also can support other items, for example and not limitation, a flag post, a sign, or like item that is desired to be positioned in a generally vertical orientation.

The base 200 can include an elongated, cylindrical shape. As a result of this shape, the base 200 includes a first end 205 and a second end 210. As illustrated, the first end 205 can be the top end, and the second end 210 can be the bottom end. The base 200 can be positioned approximately vertical, or perpendicular with respect to the support surface upon which the tree stand rests. In exemplary uses, the support surface is an outdoor surface capable of piercing without concern. The base 200 can, however, be angled other than approximately normal with respect to the support surface, in order to support the tree trunk at an angle other than approximately 90°. If the base 200 is not perpendicularly positioned with respect to its surface, then it is desired that the base 200 have an angle between approximately 75 degrees and approximately 105 degrees with respect to the surface, which range can safely be supported against falling.

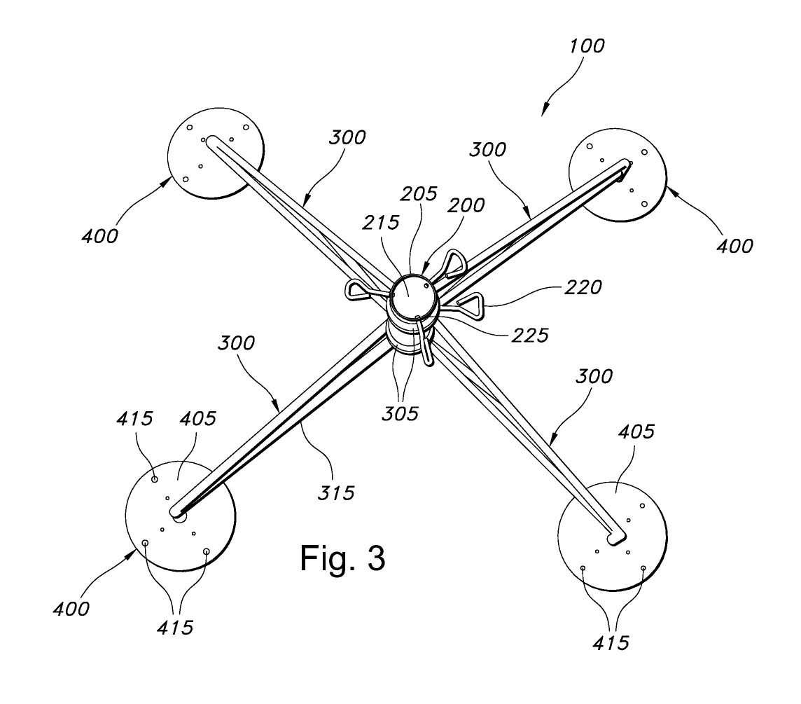

The top end 205 of the base 200 is adapted to receive the vertical structure that the tree stand 100 is to support. As shown best in FIG. 3, the base 200 having the elongated, cylindrical shape includes a hollow portion 215 defined within the base 200. The hollow portion 215 of the base 200 can be adapted to receive, e.g., the trunk of the tree.

The base 200 can be outfitted with a number of tightening mechanisms 220 to secure items smaller than that which would provide for a snug, tight fit within hollow portion 215. In an exemplary embodiment, and as illustrated, the tightening mechanisms 220 can be thumbscrews that are equally spaced about a top portion near the first end 205 of the base 200. Each thumbscrew is threaded through an aperture 225 in the top portion near the first end 205 of the base 200, in order to receive an inserted tree trunk 105, in the hollow portion 215. As one skilled in the art would appreciate, other tightening mechanisms can be utilized in order to secure the tree trunk 105 in the hollow portion 215 of the base 200.

Each leg assembly 300 of the tree stand 100 extends outwardly from the base 200 toward a support surface upon which the tree stand 100 sits, and terminates at the feet 400. The leg assemblies 300 provide support for the base 200 to secure the tree trunk a sufficient and predetermined distance above the support surface.

In an exemplary embodiment, there are at least three leg assemblies 300 of the tree stand 100. As illustrated in FIGS. 1-4, the tree stand can have four leg assemblies 300. And as one skilled in the art would appreciate, there can be more than three leg assemblies to support the tree stand 100. It is preferred, however, that the number of leg assemblies 300 be less than fifteen.

As illustrated, the leg assemblies 300 can be secured to the base 200 by a number of securing means, including snap-fit devices, welding, adhesives, pivots, hinges, and the like. The securing means selected to secure the leg assemblies 300 to the base 200 can permit collapsibility of the tree stand 100.

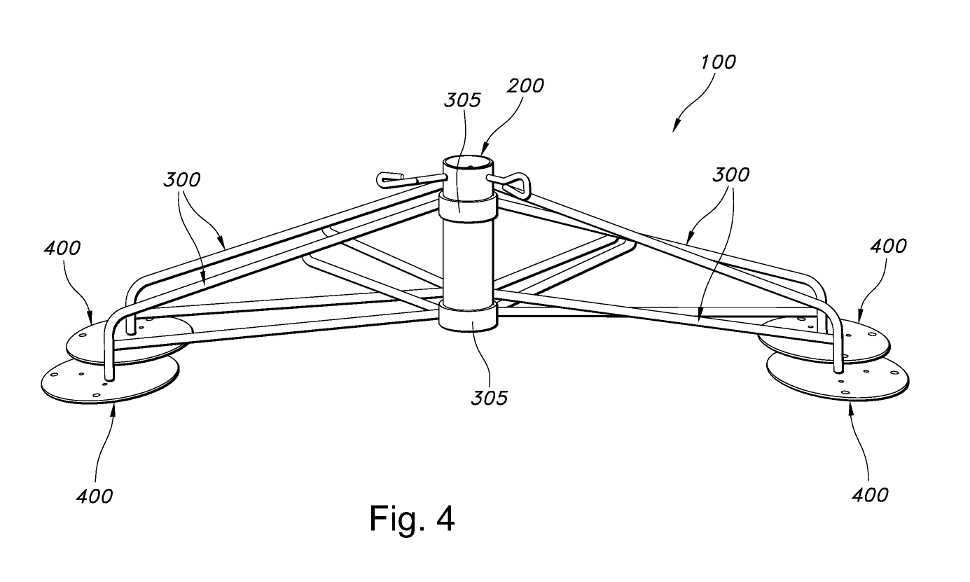

The leg assemblies 300 can be collapsible, as shown in FIG. 4. For example, the leg assemblies 300 can be secured to the base 200 by a rotatable ring 305. The leg assemblies 300 secured to the ring 305, and consequently the base 200 can be rotated inwardly toward at least one other leg assembly 300, such that the leg assemblies 300 collapse in size to reduce the size of the tree stand 100, providing ease of storage. In such an exemplary telescoping embodiment, the leg assemblies 300 of the tree stand 100 rotate from an operative position, such that if viewing the tree stand 100 from the top (see FIG. 3), the leg assemblies 300 make generally an “X” shape. When the tree stand 100 is in a packaging or inoperative position, and when viewing the tree stand 100 from the top (see FIG. 4), the leg assemblies 300 make generally a flat or straight-line shape. In the packaging position, the tree stand 100 is easily packaged and readily transportable.

As shown in FIGS. 1-4, the leg assemblies 300 can comprise at least three leg supports. For example, each leg assembly 300 comprises an angled leg support 310, a straight leg support 315, and a truss leg support 320. The angled leg support 310 extends from a top portion near the first end 205 of the base 200, outwardly toward the foot 400. In one embodiment, as the angled leg support 310 approaches the foot 400, it angles generally downward, such that it terminates in a more vertical orientation, and thus is perpendicular with respect to a top side 405 of the foot 400. The angled leg support 310 is in communication with both the base 200 and the foot 400 by a first securing means, such as welding, hinges, and the like. The straight leg support 315 extends from near the second end 210 (near a bottom portion) of the base 200 outwardly to near the terminus of the vertical orientation of the angled leg support 310, and near the foot 400. The straight leg support 315 is in communication with both the base 200 and the angled leg support 310 by a second securing means. The truss leg support 320 extends from the bottom portion of the base 200, in juxtaposition with the straight leg support 315 in communication with the base 200 (near the second end 210), at an angle toward the angled leg support 310. The truss leg support 320 can be at an angle between approximately 25 degrees and approximately 65 degrees, with respect to the support surface. The truss leg support 320 is secured to the base 200 and the angled leg support 310 by a third securing means.

In an exemplary embodiment, there are four leg assemblies—i.e., a first leg assembly, a second leg assembly, a third leg assembly, and a fourth leg assembly—which in an operative orientation are approximately normal to one another. The three leg supports for both the first leg assembly and third leg assembly are directly coupled to the base on opposing sides. The three leg supports for both the second leg assembly and the fourth leg assembly are directly coupled to the rotating ring. More specifically, the angled leg support for the second and fourth leg assemblies are coupled at opposing sides to the rotating ring positioned near the first end of the base (near the top of the base). The straight leg support and the truss leg support for the second and fourth leg assemblies are coupled at opposing sides to the rotating ring positioned near the second end of the base (near the bottom of the base).

As also illustrated in FIGS. 1-4, the leg assemblies 300 of the tree stand 100, in their operative position, are spaced evenly about the base. For example, in an exemplary embodiment in which there are a total of four leg assemblies, each leg assembly 300 is approximately 90 degrees from another leg assembly 300. Hence, collectively the four leg assemblies 300 form an X shape when in the operative position, and when being viewed from the top (see FIG. 3).

In another collapsible embodiment, the leg assemblies 300 can be pivotably attached to the base 200. A slidable collar (not shown) can be disposed about the base 200 to lock the leg assemblies 300 in their extended, operative position. This embodiment can provide an umbrella-like, collapsible design. Further, this embodiment of the tree stand 100 can provide a solid, compact, construction having an improved center of gravity over conventional designs and vertical collapsing profile for ease of storage. The leg assemblies 300 of the tree stand 100 can be broadened in width at their pivot point (not shown), and then tapered to a narrower width at their distal ends, near the feet 400. This taper provides an improved center of gravity about the tree trunk, or shaft, thus reducing the tendency of the tree to tip over. The leg assemblies 300 are sufficiently elongated to provide good balance in their extended position.

The feet 400 (each individually referred to as the “foot”) sit upon the surface to support and stabilize the tree stand 100. Each foot 400 is in communication with leg assembly 300, and can be securedly or pivotably connected thereto. As illustrated, each foot 400 can have a generally disc-like shape, which has the top side 405 and a bottom side 410. As one skilled in the art would appreciate, the shape of each foot 400 can vary. For example, the foot 400 can have a circle, disc, triangular, square, or like shape. The size of each foot 400 can vary, such that the larger the size the more stability the tree stand 100 has. The top side 405 is secured to one leg assembly 300, and the bottom side 410 rests on the surface. There are at least two apertures 415 extending through the foot 400. As illustrated, there are three or more apertures 415, equally spaced about the foot 400.

Each aperture 415 of the foot 400 can receive a stabilizing mechanism 420. In an exemplary embodiment, as illustrated in FIG. 5, the apertures 415 can receive one or more stabilizing mechanism 420, such as stake, nail, screws, and the like. By inserting one or more stabilizing mechanism 420 through the apertures 415, and thus into the support surface, the tree stand 100 is further stabilized to reduce tipping of the tree stand 100. For instance, if the surface is the ground or soil, a stake can be driven through an aperture 415 and into the ground. If the surface is a wood deck, then a nail or threaded screw can be inserted into the aperture 415, and consequently into the wood deck. If the tree stand 100 is positioned on carpet, a carpet grabber can be inserted into the aperture 415 to grip the carpet. In these situations, the tree stand 100 is better stabilized than a tree stand not having a stabilizing mechanism 420, and thus the likelihood or chance of the tree stand 100 tipping over is significantly reduced, if not eliminated. Consequently, the present invention is also a safety-prevention device, as it protects people and objects around the tree stand 100 from the tree tipping/falling over.

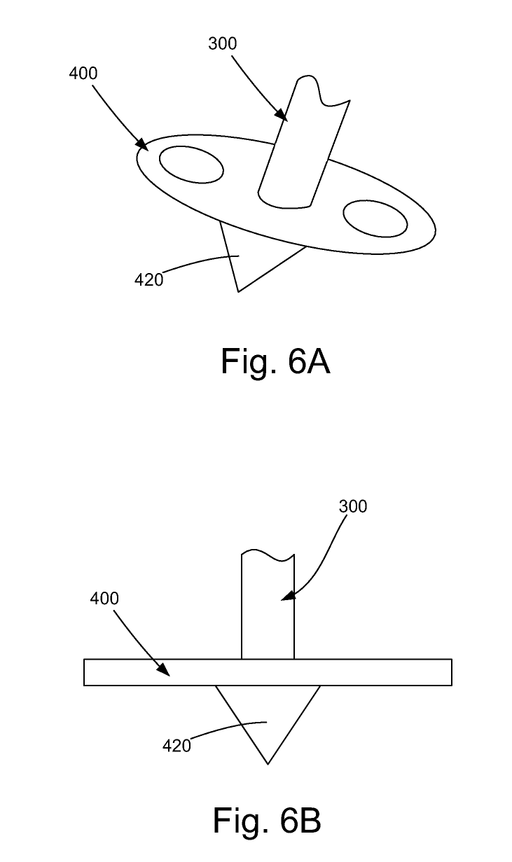

In an exemplary embodiment, one ore more feet 400 can have at least one integral stabilizing mechanism 420, as illustrated in FIGS. 6A-6B. The integral stabilizing mechanism 420 can have a varied of shapes, but is preferably adapted to penetrate a surface, such as the soil, for providing added stability to the tree stand 100.

The tree stand 100 can be positioned in both inside and outside environments. If the tree stand 100 is positioned outside, the base 200, leg assemblies 300, and feet 400 of the tree stand 100 can be rust proof and/or weather proof. Accordingly, in an exemplary embodiment, the elements of the tree stand 100 can be made of stainless steel.

The tree stand 100 can also be used for both permanent and temporary usage.

From the foregoing, it can be seen that embodiments of the present invention provide a number of different tree stands. The various embodiments of the invention described above provide tree stands having many different sizes. Therefore, unlike prior approaches, collapsibility of the tree stand can enable one to reduce the form factor of the tree stand, thereby saving valuable space when packaging or storing the tree stand.

The embodiments of the invention provide support for various items that can be desired to be placed in a general vertical orientation. The diameter of the base of the tree stand can vary based on the needs for the item to be supported vertically.

It will be appreciated by those skilled in the art, however, that the invention can be embodied in other specific forms without departing from the spirit or essential characteristics thereof. For example, while the invention has been described in the context of a tree stand for trees (both living and artificial), the concepts described herein need not be limited to these illustrative embodiments. Also, a tree stand can be manufactured via different methods, and would enjoy the same benefits as the tree stand described above.

Additionally, the specific configurations, choice of materials, and the size and shape of various elements, can be varied according to particular design specifications or constraints requiring a tree stand constructed according to the principles of embodiments of the invention. Such changes are intended to be embraced within the scope of the invention.

The presently disclosed embodiments are, therefore, considered in all respects to be illustrative and not restrictive. The scope of the invention is indicated by the appended claims, rather than the foregoing description, and all changes that come within the meaning and range of equivalents thereof are intended to be embraced therein.

What is claimed is:

1. A stand for supporting an item in a particular orientation, the stand comprising:
a base comprising an elongated, cylindrical shape defining a hollow cavity for receiving a portion of the item to be supported;
a plurality of leg assemblies in communication with the base at a first end and extending outwardly from the base, each of the plurality of leg assemblies comprising a first leg support, a second leg support, and a third leg support, collectively adapted to support the base a predetermined height from a support surface; and
a foot positioned at a second end of each of the plurality of leg assemblies to prevent tipping of the stand, each foot defining a plurality of apertures for receiving stabilizing mechanisms that are receivable therethrough.

2. The stand of claim 1, the first leg support extending from near a first end of the base outwardly toward the foot.

3. The stand of claim 2, the first leg support angles generally downward toward the foot to terminate in an approximate parallel relationship relative to the base, the first leg support in communication with the base and the foot.

4. The stand of claim 3, the second leg support extending from near a second end of the base outwardly toward near the terminus of the first leg support.

5. The stand of claim 4, the second leg support extends generally parallel with respect to the support surface and is in communication with both the base and the first leg support.

6. The stand of claim 5, the third leg support extends from near the second end of the base at an angle toward the first leg support,

7. The stand of claim 6, the third leg support is in communication with the base and the first leg support.

8. The stand of claim 7, each aperture of the foot receiving a safety-protection device for preventing tipping.

9. A tree stand for supporting a tree in a general vertical orientation, the tree stand comprising:
a base comprising an elongated, cylindrical shape defining a hollow cavity for receiving a trunk of the tree;
a plurality of leg assemblies extending outwardly from the base;
a foot positioned at the terminus of each of the plurality of leg assemblies, the foot resting on a support surface, the foot defining a plurality of apertures for receiving stabilizing mechanisms that are receivable therethrough; and
a collar positioned about the base upon which each of the plurality of leg assemblies are coupled thereto, the collar enabling rotation of the plurality of leg assemblies about the base for reduce the footprint of the tree stand.

10. The tree stand of claim 9, each of the plurality of leg assemblies comprising an angled leg support, a straight leg support, and a truss leg support, collectively adapted to support the base a predetermined height from the support surface.

11. The tree stand of claim 10, the angled leg support extends from near a first end of the base outwardly toward the foot.

12. The tree stand of claim 11, the angled leg support angles generally downward toward the foot to terminate in an approximate parallel relationship relative to the base, the angled leg support in communication with the base and secured to the foot.

13. The tree stand of claim 12, the straight leg support extends from near a second end of the base outwardly toward near the terminus of the angled leg support.

14. The tree stand of claim 13, the straight leg support extends generally parallel with respect to the support surface and is in communication with the base and coupled to the angled leg support.

15. The tree stand of claim 14, the truss leg support extends from near the second end of the base at an angle toward the angled leg support, 16. The tree stand of claim 15, the truss leg support in communication with the base and secured to the angled leg support.
